(19) United States
(12) Patent Application Publication
(10) Pub. No.: US 2026/0126533 A1
(43) Pub. Date: May 7, 2026

(54) LASER SYSTEM FOR MEASURING DISTANCE AND METHOD OF MEASURING DISTANCE

(71) Applicant: ams-OSRAM International Gmbh, Regensburg (DE)

(72) Inventor: Reiner WINDISCH, Pettendorf (DE)

(21) Appl. No.: 18/682,124

(22) PCT Filed: Aug. 8, 2022
(86) PCT No.: PCT/EP2022/072241

§ 371 Date: Feb. 8, 2024

(30) Foreign Application Priority Data
Aug. 16, 2021 (DE) 10 2021 121 211.1

(51) Int. Cl. G01S 7/4911; G01S 7/481; G01S 7/4912; G01S 17/34

(52) U.S. Cl. CPC G01S 7/4911; G01S 7/4814; G01S 7/4817; G01S 7/4818; G01S 7/4917; G01S 17/34

(57) ABSTRACT

A laser system for measuring distance includes a laser, a beam splitter configured to split laser radiation emitted by the laser into a first laser radiation and a second laser radiation. The first laser radiation and the second laser radiation each include a portion of the laser radiation emitted by the laser. The laser system includes a modulation module which is configured to change the intensity of the first laser radiation for the duration of a first time interval, and a detector, wherein the beam splitter is arranged between the laser and the modulation module. The laser is configured to continuously emit laser radiation whose frequency changes at least during a second time interval, and the detector is configured to detect at least a portion of the first laser radiation reflected at an object and at least a portion of the second laser radiation.

### CROSS-REFERENCE TO RELATED APPLICATIONS

The present application is a U.S. National Stage Application of International Application PCT/EP2022/072241, filed on Aug. 8, 2022 and claims the priority of the German application DE 10 2021 121 211.1, filed Aug. 16, 2021, the entire disclosures of the above-listed applications are hereby incorporated by reference.

### FIELD

Various embodiments of the present disclosure relate to a laser system for measuring distance and a method of measuring distance.

### BACKGROUND

For distance measurements often systems with a laser are used. One example of such systems are so-called lidar (light detection and ranging) systems. Thereby, an area is scanned with a laser from the system and, thus, the distances to various objects in this area can be determined. Distance measurements are used, for example, in the field of autonomous driving. Here, it is necessary to carry out a plurality of distance measurements in the vehicle's surroundings.

In many applications in which distance measurements are carried out, it is necessary that both the distance to an object in the environment as well as its relative speed are determined. This should be done in the shortest possible time intervals in order to achieve a high resolution.

One task to be solved is to provide an efficient laser system for distance measurement. Another task to be solved is to provide an efficient method for distance measurement.

### SUMMARY

According to at least one embodiment of the present disclosure, a laser system for measuring distance includes a laser. The laser may include a laser diode. The laser is designed to emit laser radiation during operation. The wavelength of the emitted laser radiation is arbitrary. For example, the wavelength of the emitted laser radiation can be in the infrared range.

According to at least one embodiment of the laser system for measuring distance, the laser system includes a beam splitter, which is designed to split laser radiation emitted by the laser into a first laser radiation and a second laser radiation, wherein the first laser radiation and the second laser radiation each include a portion of the laser radiation emitted by the laser. The first laser radiation can be used for distance measurement. This means that the first laser radiation can be guided to further optical elements via a waveguide and then emerge from the laser system. Thus, the laser system is designed to emit the first laser radiation. The second laser radiation can be reference radiation, which is often referred to as local oscillator. The laser system is designed in such a way that the second laser radiation remains at least mostly in the laser system. The beam splitter can include a mechanical mirror, a MEMS (micro-electro-mechanical system) mirror, an optical parametric amplifier or a grating coupler. The laser can be connected to the beam splitter via a waveguide. Thus, laser radiation emitted by the laser can reach the beam splitter via the waveguide.

According to at least one embodiment of the laser system for measuring distance, the laser system includes a modulation module, which is designed to change the intensity of the first laser radiation for the duration of a first time interval. This means that the modulation module is designed to modulate the intensity of the first laser radiation for the duration of the first time interval. Thus, during the first time interval, the first laser radiation exiting the modulation module can include a different intensity than the first laser radiation entering the modulation module. For example, the modulation module is designed to increase or amplify the intensity of the first laser radiation for the duration of the first time interval. Alternatively, the modulation module is designed to reduce or attenuate the intensity of the first laser radiation for the duration of the first time interval. Thereby, the change in the intensity of the first laser radiation relates to points in time immediately before and/or after the first time interval or to the first laser radiation entering the modulation module.

According to at least one embodiment of the laser system for measuring distance, the laser system includes a detector. The detector can be designed to detect laser radiation. The detector may be a photodetector.

According to at least one embodiment of the laser system for measuring distance, the beam splitter is arranged between the laser and the modulation module. The beam splitter can be connected to the modulation module via a waveguide. Thus, first laser radiation can pass from the beam splitter to the modulation module via the waveguide. The laser system can thus include at least two waveguides in total. The waveguides of the laser system can be single-mode fibers.

According to at least one embodiment of the laser system for measuring distance, the laser is designed to continuously emit laser radiation, whose frequency changes at least during a second time interval. It is possible that the frequency of the emitted laser radiation changes periodically. The second time interval can correspond to a period. Thus, the laser is designed to continuously emit laser radiation, whose wavelength changes at least during the second time interval. This means that the laser radiation emitted by the laser can be frequency modulated.

According to at least one embodiment of the laser system for measuring distance, the detector is configured to detect at least a portion of the first laser radiation, which was reflected at an object, and at least a portion of the second laser radiation. This can mean that the detector is configured to detect at least a portion of the first laser radiation reflected from an object. The laser system can be designed to emit at least a portion of the first laser radiation. The emitted first laser radiation can be reflected at an object in the vicinity of the laser system. The detector is designed to detect at least a portion of this reflected first laser radiation. At the same time, the detector is configured to detect at least a portion of the second laser radiation. For this purpose, the second laser radiation is directed towards the detector. This can be done via at least one mirror and at least one waveguide. The detector is thus configured to simultaneously detect reflected first laser radiation and second laser radiation impinging on it. For example, when entering the detector, the reflected first laser radiation and the second laser radiation are superimposed to form mixed radiation. For this purpose, the reflected first laser radiation and the second laser radiation can be combined in at least one fiber coupler when entering the detector or in front of the detector. The detector can include at least one fiber coupler. The detector is designed to detect this mixed radiation.

The laser system can include an optical element for decoupling the first laser radiation. The laser system can include a further optical element for coupling in the reflected first laser radiation. Alternatively, the laser system includes in total one optical element for decoupling the first laser radiation and for coupling in the reflected first laser radiation. This means that the first laser radiation is coupled out of the laser system via the optical element and the reflected first laser radiation is also coupled back into the laser system via the optical element. In this case, the optical element includes an optical circulator. Thereby, a superimposition of the first laser radiation and the reflected first laser radiation in the laser system is prevented.

According to at least one embodiment of the laser system for measuring distance, the laser system includes a laser, a beam splitter, which is designed to split laser radiation emitted by the laser into a first laser radiation and a second laser radiation, wherein the first laser radiation and the second laser radiation each include a portion of the laser radiation emitted by the laser, a modulation module, which is designed to change the intensity of the first laser radiation for the duration of a first time interval, and a detector, wherein the beam splitter is arranged between the laser and the modulation module, the laser is configured to continuously emit laser radiation, whose frequency changes at least during a second time interval, and the detector is designed to detect at least a portion of the first laser radiation, which was reflected at an object, and at least a portion of the second laser radiation.

The laser system described herein is based, among other things, on the idea that a distance to an object in the vicinity of the laser system and its relative speed in relation to the laser system can be determined simultaneously. During the first time interval, the intensity of the first laser radiation is changed compared to points in time outside the first time interval. The laser system is designed to continuously emit first laser radiation also outside the first time interval. For the portion of the first laser radiation that is emitted during the first time interval, also the reflected first laser radiation includes a measurably changed intensity. This means that by determining the duration of time between the start of the first time interval and the detection of reflected first laser radiation with changed intensity, the transit time of the first laser radiation from the laser system to the object on which the first laser radiation is reflected and back to the laser system can be determined. From this transit time, the distance of the object to the laser system can be determined. This is done in the same way as with time-of-flight (transit time) measurements. As the detection is carried out using mixed radiation from the reflected first laser radiation and the second laser radiation, this form of distance determination is a heterodyne method.

At the same time, the laser system is designed to continuously emit first laser radiation. Thereby, the frequency of the first laser radiation changes with time. The first time interval can lie within the second time interval. This means that first laser radiation, which exits the laser system, is reflected by an object and returns to the laser system, includes a longer transit time than simultaneously emitted second laser radiation, which is only directed internally to the detector. Thus, the reflected first laser radiation and the second laser radiation, which impinge on the detector at the same time, include different frequencies. As the reflected first laser radiation and the second laser radiation are superimposed when impinging on the detector, a beat, i.e. a periodic change in the intensity of the detected mixed radiation, occurs. The beat frequency corresponds to the difference frequency, i.e. the difference between the frequency of the reflected first laser radiation and the frequency of the second laser radiation. The difference frequency can be determined using a Fourier transformation. The beat frequency is proportional to the path difference between the reflected first laser radiation and the second laser radiation. From this path difference, the distance of the object from the laser system can be determined.

Thus, the distance between the laser system and the object can be determined simultaneously or almost simultaneously in two different ways. This means that a redundant measurement of the distance is possible, which increases safety. In addition, the redundant measurement can be used for an internal function test. However, determining the distance between the laser system and the object by measuring a single beat frequency only works for objects that are not moving relative to the laser system.

Furthermore, the determination of the beat frequency makes it possible that the relative speed of the object on which the first laser radiation was reflected is determined in relation to the laser system. The distance of this object from the laser system is already known from the distance measurement with the reflected first laser radiation with changed intensity. The difference frequency between the detected reflected first laser radiation and the detected second laser radiation, i.e. the beat frequency, is made up of the contribution resulting from the transit time difference between the reflected first radiation and the second laser radiation and the relative speed between the laser system and the object due to the Doppler effect. Since the distance between the laser system and the object is already known here, the relative speed is the only unknown and can therefore be determined from the difference frequency. This means that the relative speed corresponds to the difference between the detected difference frequency and the difference frequency that would occur if the object was located at the laser system at the specified distance and was not moving relative to the laser system.

Thus, in just one measurement, advantageously, the distance of the object from the laser system and its relative speed can be determined. This means that the laser system can be operated efficiently. Furthermore, advantageously, only one laser and one detector are required for this. Another advantage is that errors can be detected independently and corrected by repeat measurements. In road traffic, for example, only a limited range of relative speeds is plausible. If an implausible relative speed is determined, this can be classified as an error. In this case, the measurement can be repeated. The laser system therefore includes a function check, which increases the safety.

The laser system described here includes in particular advantages over conventional FMCW (Frequency Modulated Coninuous Wave Light) systems. In these systems, a second measurement is required for determining the relative speed, which increases the required measurement time. If two objects are illuminated simultaneously, a third measurement is also required to clearly assign the distances and relative speeds. In comparison, only one measurement is required in most cases with the laser system described here. Thus, the measurement time is overall considerably shorter. This means that the laser system can be operated efficiently.

According to at least one embodiment of the laser system for measuring distance, the detector includes a frequency filter. The frequency filter may be a bandpass filter. The frequency filter can be arranged in such a way that electromagnetic radiation hitting the detector hits the frequency filter before being detected by the detector. The frequency filter can be connected upstream of a detection area of the detector. For electromagnetic radiation with frequencies that differ significantly from the frequencies of the first laser radiation and the second laser radiation, the frequency filter can be less permeable than for the first laser radiation and the second laser radiation. Thereby, background radiation can at least partially be filtered out of the radiation impinging on the detector. This increases the accuracy of the measurement of the laser system.

According to at least one embodiment of the laser system for measuring distance, the detector includes two partial regions, wherein each partial region is configured to detect at least a portion of the first laser radiation, which was reflected at the object and at least a portion of the second laser radiation. The two partial regions can be differential detectors. The signal detected by one of the partial regions can be subtracted from the signal detected by the other of the two partial regions. Thereby, background radiation from the vicinity of the laser system, i.e. electromagnetic radiation with a low frequency, is eliminated. This increases the accuracy of the measurement of the laser system. A beam splitter is connected upstream of the two partial regions. The two partial regions can each be an AC-coupled photodiode.

According to at least one embodiment of the laser system for measuring distance, the modulation module is designed to change the intensity of the first laser radiation for the duration of the first time interval at most by a factor of 10,000 in comparison to the intensity of the first laser radiation impinging on the modulation module. This means that the modulation module is designed to increase or decrease the intensity of the first laser radiation for the duration of the first time interval at most by a factor of 10000 in comparison to the intensity of the first laser radiation impinging on the modulation module. Thus, the intensity of the first laser radiation emitted by the modulation module during the first time interval is at most a factor of 10000 higher than the intensity of the first laser radiation impinging on the modulation module. Alternatively, the intensity of the first laser radiation emitted by the modulation module during the first time interval is at most a factor of 10000 lower than the intensity of the first laser radiation impinging on the modulation module. The measurement process can be repeated for several successive first time intervals. Between the first time intervals, the intensity of the first laser radiation emitted by the laser system is different from 0. Thus, the laser system is designed to continuously emit first laser radiation outside the first time interval. This enables the determination of the relative speed from the superposition of the reflected first laser radiation and the second laser radiation.

According to at least one embodiment of the laser system for measuring distance, the modulation module is designed to change the intensity of the first laser radiation for the duration of the first time interval at most by a factor of 100000 compared to the intensity of the first laser radiation impinging on the modulation module.

According to at least one embodiment of the laser system for measuring distance, the modulation module is designed to reduce the intensity of the first laser radiation at at least some points in time outside the first time interval compared to the intensity of the first laser radiation during the duration of the first time interval. The modulation module can be designed to absorb a part of the first laser radiation impinging on the modulation module at at least some points in time outside the first time interval. Thus, the intensity of the first laser radiation, which emerges from the modulation module at these points in time outside the first time interval is reduced compared to the intensity of the first laser radiation impinging on the modulation module. The modulation module is further designed to absorb a smaller portion of the first laser radiation during the first time interval than at at least some points in time outside the first time interval. Thus, the intensity of the first laser radiation that emerges from the modulation module during the first time interval is higher than the intensity of the first laser radiation that emerges from the modulation module at at least some points in time outside the first time interval. Thus, the intensity of the first laser radiation emerging from the modulation module is increased in a pulse-like manner during the first time interval in comparison to at least some points in time outside the first time interval. Thus, the intensity of the reflected first laser radiation is also increased in a pulse-like manner in a time interval. Advantageously, the distance of the object from the laser system can be determined from the transit time of the first laser radiation with increased intensity.

According to at least one embodiment of the laser system for measuring distance, the modulation module is designed to increase the intensity of the first laser radiation for the duration of the first time interval compared to the intensity of the first laser radiation impinging on the modulation module. This can mean that the modulation module is designed to amplify the intensity of the first laser radiation for the duration of the first time interval compared to the intensity of the first laser radiation impinging on the modulation module. For this purpose, the modulation module can include an amplifier which is designed to amplify the intensity of the first laser radiation for the duration of the first time interval. Thus, it is achieved in a different way that the intensity of the first laser radiation is increased in a pulse-like manner during the first time interval.

According to at least one embodiment of the laser system for measuring distance, the modulation module includes an electro-optical modulator. The electro-optical modulator can be designed to absorb at least 40% of the first laser radiation at at least some points in time outside the first time interval. The electro-optical modulator can be designed to absorb at least 50% and may be at least 90% of the first laser radiation at at least some points in time outside the first time interval. Further, the electro-optical modulator can be designed to absorb at most 20% or at most 10% of the first laser radiation during the first time interval. The electro-optical modulator can be a Mach-Zehnder modulator or an absorbing electro-optical modulator. With the electro-optical modulator, the shape of the pulse-like increased intensity of the first laser radiation can advantageously be well controlled. An amplifier can be arranged downstream of the electro-optical modulator.

According to at least one embodiment of the laser system for measuring distance, the modulation module includes an amplifier. The amplifier can be designed to amplify the intensity of the first laser radiation for the duration of the first time interval compared to the intensity of the first laser radiation impinging on the modulation module. The amplifier can be a pulsed pumped amplifier, i.e. an amplifier that is excited at least by a pulsed pump laser. Thereby, the first laser radiation impinging on the amplifier is amplified during the pump pulse. When using an amplifier, the laser system can include in total fewer components than when using an electro-optical modulator, because when using an electro-optical modulator in most cases also an amplifier is required. Thus, the laser system with an amplifier can advantageously include a smaller size.

According to at least one embodiment of the laser system for measuring distance, the laser system includes a sensor for detecting the laser radiation emitted by the amplifier. The sensor can thus be arranged downstream of the amplifier. The sensor can include a monitor detector diode. Thus, it can be checked how high the power of the laser radiation emitted by the amplifier is. In case that the power is higher than a permitted or predeterminable limit value, the power of the laser radiation emitted by the amplifier can be reduced. The permitted limit value can depend on which power is maximally permitted in road traffic or which power is maximally permitted for people. Thus, people in the vicinity of the laser system can be protected from too high or harmful power of the emitted laser radiation.

According to at least one embodiment of the laser system for measuring distance, the laser system includes a waveguide for guiding the first laser radiation, wherein the waveguide is at least 50 cm long. The waveguide can be a delay line or a fiber winding. The waveguide can be integrated into a photonic integrated circuit. The laser system includes the waveguide to extend the distance that the first laser radiation travels between the beam splitter and the detector. This also enables the detection of objects, which include only a short distance to the laser system. So, the difference frequency between the reflected first laser radiation and the second laser radiation is very small for very short distances to the object. This means that the beat period is relatively large. To enable a reliable distance measurement, it is necessary that the first time interval is at least as long as a beat period. Thus, for short distances to the object longer first time intervals are required. The precision of the distance measurement is, however, greater the shorter the first time interval is. By using the waveguide, the transit time of the reflected first laser radiation is increased. This results in that the difference frequency is greater and therefore the beat period is shorter. Thus, in this case, the first time interval can be shorter, which advantageously increases the precision of the distance measurement. Another possibility to increase the difference frequency is to increase the difference frequency of the laser.

According to at least one embodiment of the laser system for measuring distance, the frequency of the laser radiation emitted by the laser changes linearly with the time during the second time interval. The frequency of the laser radiation emitted by the laser can linearly increase or decrease during the second time interval. Such an increase or decrease is often referred to as Chirp. The change in the frequency of the laser radiation emitted by the laser enables the detection of a beat frequency, from which the relative speed of the object can be determined.

According to at least one embodiment of the laser system for measuring distance, the frequency of the laser radiation emitted by the laser changes in total by at least 500 MHz during the second time interval. This means, the frequency of the laser radiation emitted by the laser at the beginning of the second time interval differs by at least 500 MHz from the frequency of the laser radiation emitted by the laser at the end of the second time interval. This allows sufficiently large difference frequencies, which enables a distance measurement with great precision. For instance, the frequency of the laser radiation emitted by the laser changes during the second time interval in total by at least 1 GHz, for example, by at least 2 GHz or at least 5 GHz.

According to at least one embodiment of the laser system for measuring distance, the duration of the first time interval is at least 1 ns and at most 200 ns. For the measurement of short distances, the duration of the first time interval can be longer than for the measurement of longer distances. For example, the duration of the first time interval can be at least 2 ns or at least 10 ns. The duration of the first time interval can be at most 100 ns, for example.

The duration of the first time interval can be adapted to the expected distance of the object. If a greater distance to the object is expected, the first time interval can be shorter.

If a shorter distance to the object is expected, the first time interval can be longer. Thus, the length of the first time interval can be different for different measurements. The power of the first laser radiation in the first time interval can be adapted to the length of the first time interval. Thus, the power can be higher for shorter first time intervals than for longer first time intervals. Thus, the total power is limited to a permitted or predeterminable limit value. At higher powers of the first laser radiation, the range of the distance measurements is increased.

According to at least one embodiment of the laser system for measuring distance, the duration of the second time interval is at least 1 μs and at most 100 μs. The duration of the second time interval should be longer than the expected transit time of the first laser radiation to the object and back to the laser system. Only after this transit time a beat can be measured. For this, the second time interval must still be running at this point in time for the beat to occur. In addition, the second time interval should not end immediately with the impingement of the reflected first laser radiation on the detector, but there should still be time left to measure the beat frequency. It follows from these requirements that the duration of the second time interval is at least 1 μs and at most 100 μs. A typical transit time for the first laser radiation to the object and back to the laser system is about 2 μs. Thus, the second time interval can be at least 2 μs and at most 20 μs. This means that a measurement of the distance to the object and of the relative speed of the object is already possible in just a few microseconds.

Further, a method for measuring distance is provided. The laser system for measuring distance can be used in methods described herein. Furthermore, a laser system described herein can be used to perform the method for measuring distance. In other words, all features disclosed for the laser system are also be disclosed for the method for measuring distance and vice versa.

According to at least one embodiment of the method for measuring distance, the method includes a method step in which laser radiation is continuously emitted by a laser. The laser system includes the laser.

According to at least one embodiment of the method for measuring distance, the method includes a method step in which the laser radiation emitted by the laser is split into a first laser radiation and a second laser radiation, wherein the first laser radiation and the second laser radiation each include a portion of the laser radiation emitted by the laser. The laser radiation emitted by the laser can be split into the first laser radiation and the second laser radiation by means of a beam splitter.

According to at least one embodiment of the method for measuring distance, the method includes a method step, in which the intensity of the first laser radiation is changed for the duration of a first time interval. The intensity of the first laser radiation can be changed by a modulation module during the first time interval.

According to at least one embodiment of the method for measuring distance, the method includes a method step in which at least a portion of the first laser radiation, which was reflected at an object, and at least a portion of the second laser radiation is detected with a detector. The object is arranged outside the laser system. The laser system includes the detector.

According to at least one embodiment of the method for measuring distance, the frequency of the laser radiation emitted by the laser changes at least during a second time interval.

According to at least one embodiment of the method for measuring distance, the method includes the steps of continuously emitting laser radiation by a laser, splitting the laser radiation emitted by the laser into a first laser radiation and a second laser radiation, wherein the first laser radiation and the second laser radiation each include a portion of the laser radiation emitted by the laser, changing the intensity of the first laser radiation for the duration of a first time interval, and detecting at least a portion of the first laser radiation, which was reflected at an object, and at least a portion of the second laser radiation with a detector, wherein the frequency of the laser radiation emitted by the laser changes at least during a second time interval.

The method for measuring distance has, amongst others, the advantage that, as described for the laser system, a distance to an object in the vicinity of the laser system and its relative speed with respect to the laser system can be determined simultaneously.

According to at least one embodiment of the method, at at least some points in time outside the first time interval at least 40% of the first laser radiation is absorbed by an electro-optical modulator and during the first time interval at most 10% of the first laser radiation is absorbed by the electro-optical modulator. The laser system includes the electro-optical modulator. During the first time interval, the absorption of the electro-optical modulator is thus lower than at at least some points in time outside the first time interval. It is thus achieved that the intensity of the first laser radiation, which is emitted by the modulation module with the electro-optical modulator, is increased in a pulse-like manner during the first time interval in comparison to the intensity of the first laser radiation which impinges on the modulation module. With this pulse-like increased intensity, it is possible to determine the distance of the object to the laser system.

According to at least one embodiment of the method, the intensity of the first laser radiation during the first time interval is increased by an amplifier compared to the intensity of the first laser radiation at at least some points in time outside the first time interval. This means that the intensity of the first laser radiation during the first time interval is increased by the amplifier compared to the intensity of the first laser radiation impinging on the amplifier. This also increases the intensity of the first laser radiation in the first time interval in a pulse-like manner.

According to at least one embodiment of the method, the distance of the object from the detector is determined from the transit time of the first laser radiation with the changed intensity across the object to the detector. The signal detected by the detector is proportional to \sqrt{P_{R}*P(t)}sin(Δωt). Thereby, P_{R} is the power of the second laser radiation impinging on the detector, P(t) is the time-dependent reflected first laser radiation detected by the detector and Δω is the difference frequency. Via determining the envelope of the signal detected by the detector, the point in time of arrival of the reflected first laser radiation with changed intensity can be determined. The time difference between the start of the first time interval and the arrival of the reflected first laser radiation with changed intensity can be used to determine the transit time from the laser system to the object and back. Using the speed of light, the distance of the object from the laser system can be determined. It is also possible to determine the distance of the object from the laser system from the transit time of the first laser radiation with the changed intensity via the object to the laser system or to the detector.

According to at least one embodiment of the method, a speed of the object relative to the detector is determined from the determined distance and from the difference between the frequency of the second laser radiation and the frequency of the first laser radiation reflected at the object for first laser radiation and second laser radiation which impinge on the detector simultaneously at a point in time outside the first time interval. As described above, the speed of the object relative to the detector or relative to the laser system is determined from the measured beat frequency. For this purpose, the signal that the detector detects is recorded and the beat frequency is determined using a Fourier transformation of the signal. The beat frequency can be measured after the impingement of the reflected first laser radiation with changed intensity on the detector. It is advantageous to provide the first time interval at the beginning of the second interval or near the beginning of the second time interval. Thus, after the detection of the reflected first laser radiation with changed intensity, enough time of the second time interval remains to measure the beat frequency with sufficient accuracy. Advantageously, background radiation does not influence the beat frequency, as background radiation is generally not coherent with the emitted laser radiation and therefore does not contribute to the beat. As the laser system includes the detector, here and in the following it is each possible to determine the distance between the laser system and the object and the distance between the detector and the object. It is further possible to determine the relative speed between the laser system and the object and the relative speed between the detector and the object, as both relative speeds are equal.

According to at least one embodiment of the method, the distance of the object from the detector is determined from the difference between the frequency of the second laser radiation and the frequency of the first laser radiation reflected at the object for first laser radiation and second laser radiation which impinge on the detector simultaneously at a point in time outside the first time interval. In this case, the determination of the distance is done as described above using the beat frequency in case that the object is not moving relative to the detector.

According to at least one embodiment of the method, the frequency of the laser radiation emitted by the laser increases linearly with time during the second time interval and the frequency of the laser radiation emitted by the laser decreases linearly with time during a third time interval. Alternatively, it is possible that the frequency of the laser radiation emitted by the laser decreases linearly with time during the second time interval and the frequency of the laser radiation emitted by the laser increases linearly with time during the third time interval. The third time interval can start directly after the end of the second time interval. The distance of the object from the detector can be determined from the beat frequency for the second time interval and for the third time interval. This means that two difference frequencies are determined. If the object moves relative to the detector, the relative speed of the object results from the difference between the two determined difference frequencies. The distance of the object from the detector can be determined from the mean value of the two difference frequencies. It is also possible to use a measurement during the third time interval to assign different measured distances and relative speeds to different objects in the vicinity of the detector. If the first laser radiation is reflected at two or more objects in the vicinity of the detector, the different distances can be determined from the reflected first laser radiation with increased intensity and different difference frequencies are measured. In many cases, it is possible to assign the measured distances to the respective measured relative speeds for reasons of plausibility. So, in road traffic, for example, certain distances and certain speeds can be excluded. If an assignment is not clearly possible, for example in the case of two objects, which are moving in opposite directions, this can be done via a measurement during the third time interval. Thereby, the distances and relative speeds are determined for the third time interval as described above.

According to at least one embodiment of the method, the first time interval and the second time interval start simultaneously or the first time interval starts at most 200 ns after the second time interval. This means that the signal detected by the detector at the beginning of the measured beat includes a changed intensity in comparison with the remaining second time interval. This has the advantage that the entire remaining duration of the second time interval after the detection of the reflected first laser radiation with changed intensity remains for the measurement of the beat frequency. This enables an accurate determination of the beat frequency, which increases the precision of the measurement of the relative speed. The time during which the reflected first laser radiation with changed intensity is detected cannot be used for the measurement of the beat frequency. Advantageously, the end of the pulse with changed intensity in the detected signal thus marks the start of the measurement of the beat frequency.

According to at least one embodiment of the method, the method is used to scan a plurality of points. With the method a plurality of points or areas in the vicinity of the laser system can be scanned. This means that for a plurality of points or areas in the vicinity of the laser system the distance of one or more objects at these points or in these areas and their relative speeds are determined. The measurements for the individual points or areas can be carried out one after the other. Thus, advantageously, a three-dimensional image of the vicinity of the laser system can be determined.

### BRIEF DESCRIPTION OF THE DRAWINGS

In the following, the laser system described herein and the method for measuring distance described herein are explained in more detail in connection with exemplary embodiments and the associated figures.

FIG. 1 shows an arrangement for measuring distance.

FIG. 2 shows a laser system according to an exemplary embodiment.

FIG. 3 shows a laser system according to a further exemplary embodiment.

With FIGS. 4, 5, 6, 7 and 8 an exemplary embodiment of the method for measuring distance is described.

Elements that are identical, similar or have the same effect are marked with the same reference signs in the figures. The figures and the proportions of the elements shown in the figures are not to be regarded as being true to scale. Rather, individual elements may be shown exaggeratedly large for better visualization and/or better comprehensibility.

### DETAILED DESCRIPTION

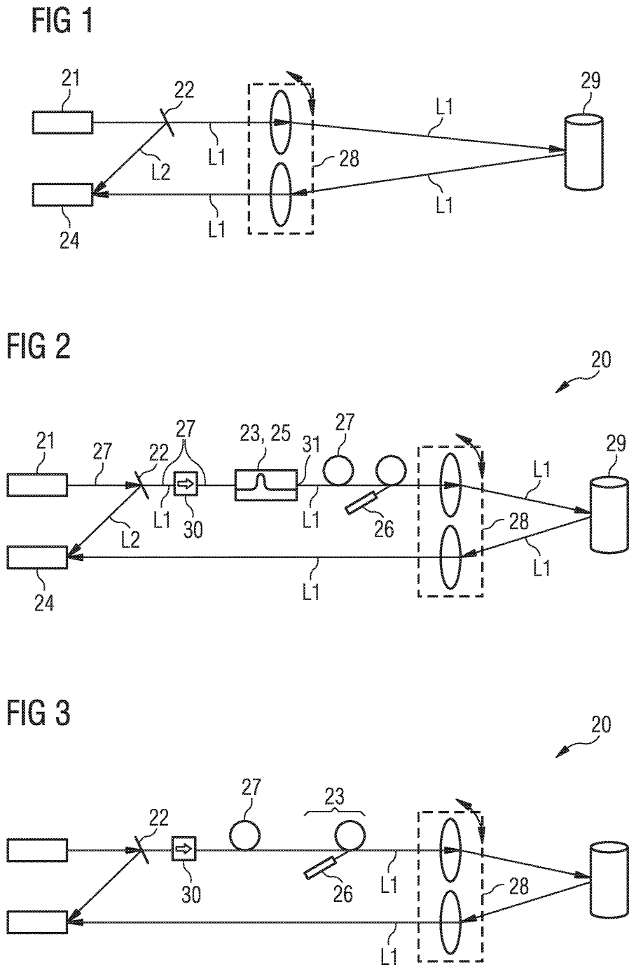

In FIG. 1 an arrangement for measuring distance is shown, which is not an exemplary embodiment. The arrangement includes a laser 21. The laser 21 is designed to emit laser radiation during operation. The laser radiation is represented by a line. The arrangement further includes a beam splitter 22. The beam splitter 22 splits the impinging laser radiation into first laser radiation L1, which propagates in the same direction as before the beam splitter 22, and second laser radiation L2, which is directed towards a detector 24. The first laser radiation L1 passes an optical element 28, is reflected by an object 29 and passes through the optical element 28 to the detector 24. The optical element 28 can be rotated, which is shown by an arrow. Thus, the first laser radiation L1 can be directed to different points or areas in the vicinity of the arrangement. Via a time-of-flight measurement, the distance of the object 29 from the detector 24 can be determined. If the optical element 28 is rotated, the distances to various objects in the vicinity of the arrangement can be determined.

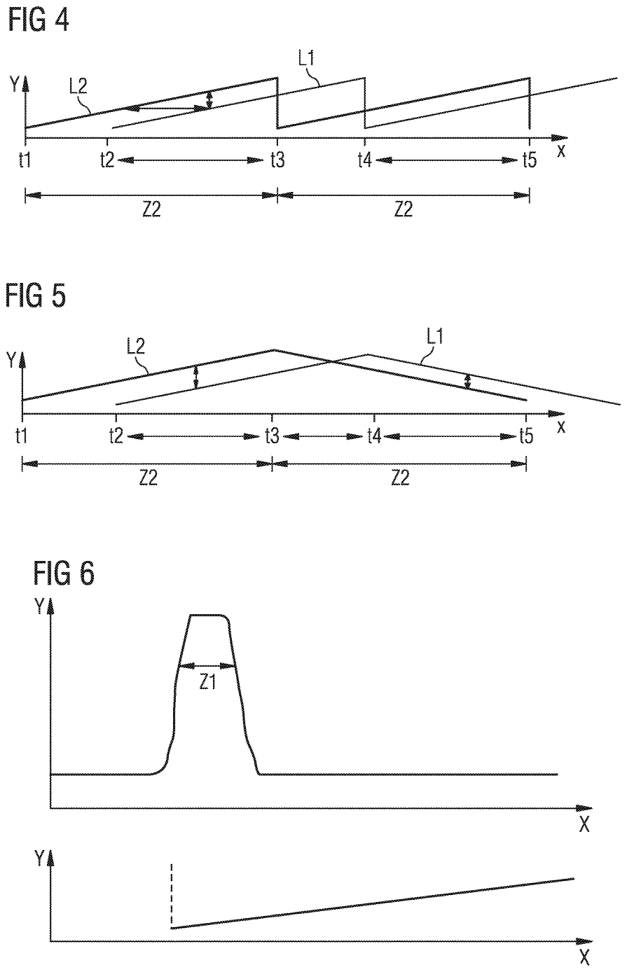

In FIG. 2 a laser system 20 for measuring distance according to an exemplary embodiment is shown. The laser system 20 includes a laser 21. The laser 21 is designed to continuously emit laser radiation, the frequency of which changes at least during a second time interval Z2. The laser system 20 further includes a beam splitter 22, which is designed to split laser radiation emitted by the laser 21 into a first laser radiation L1 and a second laser radiation L2. The first laser radiation L1 and the second laser radiation L2 each include a portion of the laser radiation emitted by the laser 21. Between the laser 21 and the beam splitter 22 a waveguide 27 is arranged, in which the emitted laser radiation is guided.

The laser system 20 further includes a modulation module 23, which is designed to change the intensity of the first laser radiation L1 for the duration of a first time interval Z1. The modulation module 23 is designed to change the intensity of the first laser radiation L1 for the duration of the first time interval Z1 at most by a factor of 10000 compared to the intensity of the first laser radiation L1 impinging on the modulation module 23. This is achieved by the modulation module 23 being designed to reduce the intensity of the first laser radiation L1 at at least some points in time outside the first time interval Z1 compared to the intensity of the first laser radiation L1 during the duration of the first time interval Z1.

The modulation module 23 is connected to the beam splitter 22 via a waveguide 27. Thus, the beam splitter 22 is arranged between the laser 21 and the modulation module 23. The modulation module 23 includes an electro-optical modulator 25.

An optical isolator 30 is optionally arranged between the beam splitter 22 and the modulation module 23. The optical isolator 30 can include a Faraday filter. Thus, a feedback of radiation into the laser 21 is prevented.

The laser system 20 further includes a waveguide 27 for guiding the first laser radiation L1, wherein the waveguide 27 is at least 50 cm long. Thus, the waveguide 27 is a delay line. The waveguide 27 is connected to an output 31 of the modulation module 23.

The laser system 20 further includes an amplifier 26. The amplifier 26 is connected to the waveguide 27, which is a delay line. The amplifier 26 is designed to amplify the intensity of the first laser radiation L1 constantly over time. The amplifier 26 can be a continuously pumped amplifier. Advantageously, the delay line is thus arranged in front of the amplifier 26. This minimizes the absolute power losses.

The positions of the modulation module 23 and of the waveguide 27, which is the delay line, may be reversed.

The laser system 20 further includes an optical element 28 as shown in FIG. 1. After passing the optical element 28, the first laser radiation L1 emerges from the laser system 20. The first laser radiation L1 propagates to an object 29 and is reflected by it. The reflected first laser radiation L1 re-enters the laser system 20 via the optical element 28.

The laser system 20 further includes a detector 24. The second laser radiation L2 is directed towards the detector 24 by the beam splitter 22. The reflected first laser radiation L1 is directed towards the detector 24 by the optical element 28. The detector 24 is configured to detect at least a portion of the first laser radiation L1, which was reflected at the object 29 and at least a portion of the second laser radiation L2. The detector 24 is configured to detect a superposition of the reflected first laser radiation L1 and the second laser radiation L2.

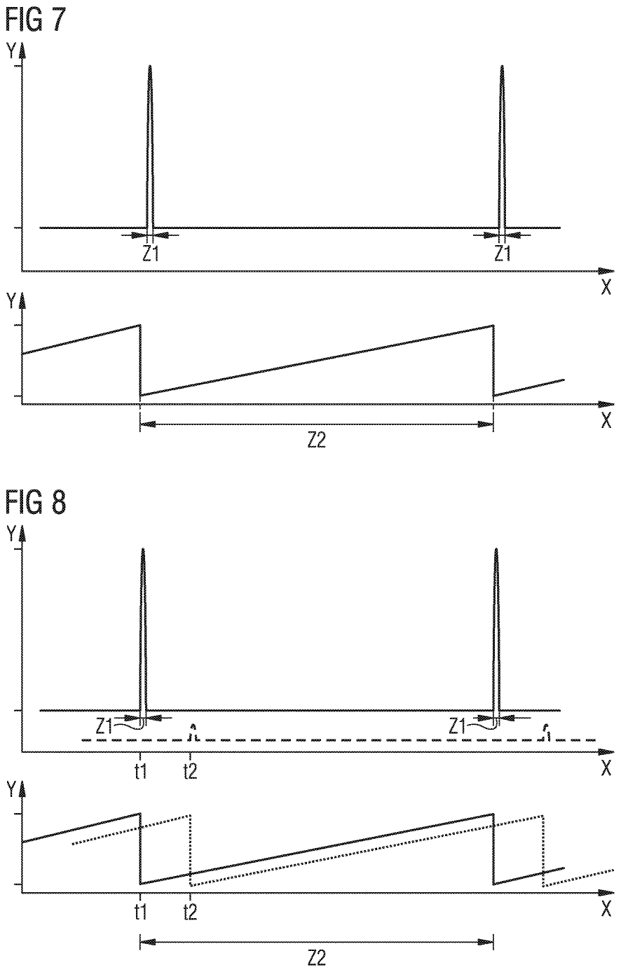

FIG. 3 shows a further exemplary embodiment of the laser system 20. In contrast to the exemplary embodiment shown in FIG. 2, the modulation module 23 includes the amplifier 26, a pulsed pump laser. The optical isolator 30 is arranged between the beam splitter 22 and the waveguide 27, which is the delay line. The modulation module 23 is arranged between this waveguide 27 and the optical element 28. The modulation module 23 is designed to increase the intensity of the first laser radiation L1 for the duration of the first time interval Z1 compared to the intensity of the first laser radiation L1 impinging on the modulation module 23. The amplification of the intensity is done by the amplifier 26.

With the FIGS. 4, 5, 6, 7 and 8 an exemplary embodiment of the method for measuring distance is described.

In FIG. 4, the frequencies of at least a part of the laser radiation detected by the detector 24 are plotted against time. The time is plotted on the x-axis and the frequencies are plotted on the y-axis. The first line represents the frequency curve of the second laser radiation L2 hitting the detector 24. The frequency of the laser radiation emitted by the laser 21 changes linearly with time during the second time interval Z2. Thus, the frequency of the second laser radiation L2 detected by the detector 24 also changes linearly with time. The frequency of the laser radiation emitted by the laser 21 can change during the second time interval Z2 in total by at least 500 MHz.

The second line represents the frequency curve of the reflected first laser radiation L1 impinging on the detector 24. The first laser radiation L1 with the lowest frequency has traveled a longer distance to the detector 24 than the second laser radiation L2 with the lowest frequency. Thus, the second laser radiation L2 with the lowest frequency is detected earlier than the first laser radiation L1 with the lowest frequency. From a first point in time t1, the second laser radiation L2 is detected. From a second point in time t2, at which the detector 24 also detects first laser radiation L1, the frequency of the detected second laser radiation L2 and the frequency of the detected first laser radiation L1 include a difference. From this difference frequency, the distance of the object 29 from the laser system 20 or the relative speed of the object 29 can be determined as described above.

The difference frequency can be determined up to a third point in time t3. The third point in time t3 is given by the fact that since the first point in time t1 the entire duration of the second time interval Z2 has elapsed. At the third point in time t3, the second laser radiation L2 includes a frequency jump. From the third point in time t3, it is no longer possible to determine the difference frequency.

A second measurement is possible from a fourth point in time t4, at which the detector 24 again detects first laser radiation L1 and second laser radiation L2, both of which were emitted by the laser 21 during the same second time interval Z2. In the second measurement, to the determination of the difference frequency is possible up to a fifth point in time t5, at which the detected second laser radiation L2 again includes a frequency jump.

In FIG. 5 the same measuring principle as in FIG. 4 is shown, with the difference that the frequency of the laser radiation emitted by the laser 21 increases linearly with time during the second time interval Z2 and, without a frequency jump, the frequency of the laser radiation emitted by the laser 21 decreases linearly with time during a directly following third time interval Z3. Therefore, the frequency of the detected first laser radiation L1 and the frequency of the detected second laser radiation L2 initially increases linearly and then decreases linearly. The difference frequency can be determined in the same way as described with FIG. 4 between the second point in time t2 and the third point in time t3 and between the fourth point in time t4 and the fifth point in time t5.

In FIG. 6 the intensity distribution of the first laser radiation L1 is shown in the upper diagram. Thereby, the time is plotted on the x-axis and the intensity is plotted on the y-axis. In the first time interval Z1, the intensity of the first laser radiation L1 is increased compared to points in time outside the first time interval Z1. Ideally, the intensity pulse shown in the upper diagram would be rectangular, but in reality the intensity pulse includes rise and fall times and arbitrary edge shapes as shown in FIG. 6. This intensity pulse is generated by the fact that at at some points in time outside the first time interval Z1 at least 40% of the first laser radiation L1 are absorbed by the electro-optical modulator 25 of the exemplary embodiment shown in FIG. 2 and during the first time interval Z1 at most 10% of the first laser radiation L1 are absorbed by the electro-optical modulator 25. Alternatively, the intensity pulse is generated by increasing the intensity of the first laser radiation L1 during the first time interval Z1 by the amplifier 26 of the exemplary embodiment of FIG. 3 compared to the intensity of the first laser radiation L1 at at least some points in time outside the first time interval Z1.

In the lower diagram in FIG. 6, the time is plotted on the x-axis and the frequency of the first laser radiation L1 is plotted on the y-axis. The frequency of the first laser radiation L1 increases linearly with time from the start of the first time interval Z1. The time axes shown in the upper diagram and in the lower diagram show the same time period. The time section shown is only a part of the second time interval Z2.

In FIG. 7, the signals shown in FIG. 6 are plotted for a longer time period. So, in the upper diagram, the time is plotted on the x-axis and the intensity of the first laser radiation L1 is plotted on the y-axis. In the lower diagram, the time is plotted on the x-axis and the frequency of the first laser radiation L1 is plotted on the y-axis. Overall, a time period is shown which is longer than the second time interval Z2. The duration of the first time interval Z1 can be at least 1 ns and at most 200 ns. The duration of the second time interval Z2 can be at least 1 μs and at most 100 μs.

With FIG. 8 an exemplary embodiment of the method for measuring distance is described. According to the method, laser radiation is continuously emitted by the laser 21. The laser radiation emitted by the laser 21 is divided into the first laser radiation L1 and the second laser radiation L2 via a beam splitter 22. The frequency of the laser radiation emitted by the laser 21 changes linearly during the second time interval Z2. The detector 24 detects at least a portion of the first laser radiation L1, which was reflected at the object 29 and at least a portion of the second laser radiation L2. In FIG. 8, in the lower diagram the frequency of the first laser radiation L1 emitted by the laser system 20 is plotted over time with the solid line. Thereby, the time is plotted on the x-axis and the frequency of the first laser radiation L1 is plotted on the y-axis. As the frequency of the laser radiation emitted by the laser 21 changes linearly with time, the frequency of the first laser radiation L1 also changes linearly with time. Thereby, the frequency of the first laser radiation L1 increases during the second time interval Z2 from a minimum value up to a maximum value. At the end of the second time interval Z2, there is a frequency drop and the frequency of the first laser radiation L1 increases again from the minimum value to the maximum value in the directly following second time interval Z2. With the dashed line, the frequency of the reflected first laser radiation L1 detected at the detector 24 is plotted over time. Due to the transit time of the first laser radiation L1 from the laser system 20 to the object 29 and back to the laser system 20, the reflected first laser radiation L1 includes the same frequency curve with a time offset as the first laser radiation L1 emitted by the laser system 20.

With the upper diagram in FIG. 8 it is shown that the intensity of the first laser radiation L1 is changed for the duration of the first time interval Z1. In the upper diagram, the time is plotted on the x-axis and the intensity of the first laser radiation L1 is plotted on the y-axis. With the solid line the intensity of the first laser radiation L1 emitted by the laser system 20 is shown. During the first time interval Z1, the intensity of the first laser radiation L1 is significantly increased compared to points in time outside the first time interval Z1. Thereby, the first time interval Z1 and the second time interval Z2 start simultaneously at a first point in time t1. The time axes shown in FIG. 8 show the same time period.

With the dashed line in the upper diagram the intensity of the reflected first laser radiation L1 detected by the detector 24 is shown. The intensity of the reflected first laser radiation L1 is overall lower than the intensity of the first laser radiation L1 emitted by the laser system 20. This is due to losses in the intensity of the first laser radiation L1 on the path away from the laser system 20 and back to the laser system 20. At a second point in time t2, the detector 24 detects an increased intensity of the detected laser radiation compared to points in time prior to and after the second point in time t2. Thus, at the second point in time t2, the first laser radiation L1 with the increased intensity, which was emitted by the laser system 20 at the first point in time t1 during the first time interval Z1, impinges on the detector 24. This means that the time difference between the first point in time t1 and the second point in time t2 corresponds to the transit time of the first laser radiation L1 from the laser system 20 to the object 29 and back to the laser system 20. The distance of the object 29 from the laser system 20 can be determined from this transit time.

The speed of the object 29 relative to the detector 24 or relative to the laser system 20 can now be determined from this determined distance and from the difference between the frequency of the second laser radiation L2 and the frequency of the first laser radiation L1 reflected at the object 29 for first laser radiation L1 and second laser radiation L2 which impinge simultaneously on the detector 24 at a point in time outside the first time interval Z1. This determination of the relative speed is carried out as described in FIG. 4. In addition, the distance of the object 29 from the detector 24 can also be determined from the difference between the frequency of the second laser radiation L2 and the frequency of the first laser radiation L1 reflected at the object 29 for first laser radiation L1 and second laser radiation L2 which simultaneously impinge on the detector 24 at a point in time outside the first time interval Z1.

With the method in total a plurality of points in the vicinity of the laser system 20 can be scanned.

The features and exemplary embodiments described in connection with the figures can be combined with one another in accordance with further exemplary embodiments, even if not all combinations are explicitly described. Furthermore, the exemplary embodiments described in connection with the figures can alternatively or additionally include further features according to the description in the general part.

The present disclosure is not limited to the description based on the exemplary embodiments. Rather, the present disclosure includes any new feature as well as any combination of features, which includes in particular any combination of features in the patent claims, even if this feature or this combination itself are not explicitly stated in the patent claims or exemplary embodiments.

### REFERENCES

20 laser system
21 laser
22 beam splitter
23 modulation module
24 detector
25 electro-optical modulator
26 amplifier
27 waveguide
28 optical element
29 object
30 optical isolator
31 output
L1 first laser radiation
L2 second laser radiation
t1-t5 time points
Z1 first time interval
Z2 second time interval
Z3 third time interval

1. A laser system for measuring distance, the laser system comprising:
a laser,
a beam splitter configured to split laser radiation emitted by the laser into a first laser radiation and a second laser radiation, wherein the first laser radiation and the second laser radiation each comprise a portion of the laser radiation emitted by the laser.
a modulation module configured to change an intensity of the first laser radiation for the duration of a first time interval, and
a detector,
wherein
the beam splitter is arranged between the laser and the modulation module,
the laser configured to continuously emit laser radiation whose frequency changes at least during a second time interval, and
the detector is configured to detect at least a portion of the first laser radiation, which was reflected at an object, and at least a portion of the second laser radiation, and
the modulation module is configured to change the intensity of the first laser radiation in a pulse-like manner during the first time interval.

2. The laser system according to claim 1, wherein the modulation module configured to change the intensity of the first laser radiation for the duration of the first time interval by at most a factor of 10,000 compared to the intensity of the first laser radiation impinging on the modulation module/

3. The laser system according to claim 1, wherein the modulation module is configured to reduce the intensity of the first laser radiation at one or more points in time outside the first time interval compared to the intensity of the first laser radiation during the duration of the first time interval or to increase the intensity of the first laser radiation for the duration of the first time interval compared to the intensity of the first laser radiation impinging on the modulation module.

4. The laser system according to claim 1, wherein the modulation module comprises an electro-optical modulator.

5. The laser system according to claim 1, wherein the modulation module comprises an amplifier.

6. The laser system according to claim 1, wherein the laser system comprises a waveguide for guiding the first laser radiation wherein the waveguide is at least 50 cm long.

7. The laser system according to claim 1, wherein the laser is configured to continuously emit laser radiation so that the frequency of the laser radiation emitted by the laser changes linearly with time during the second time interval.

8. The laser system according to claim 1, wherein the laser is configured to continuously emit laser radiation so that the frequency of the laser radiation emitted by the laser changes during the second time interval by a total of at least 500 MHz.

9. The laser system according to claim 1, wherein the duration of the first time interval is at least 1 ns and at most 200 ns.

10. The laser system according to claim 1, wherein the duration of the second time interval is at least 1 μs and at most 100 μs.

11. A method of measuring distance, the method comprising:
continuous emission of laser radiation by a laser,
splitting of the laser radiation emitted by the laser into a first laser radiation and a second laser radiation, wherein the first laser radiation and the second laser radiation each comprise a portion of the laser radiation emitted by the laser,
changing an intensity of the first laser radiation for the duration of a first time interval, and
detecting of at least a portion of the first laser radiation reflected at an object and at least a portion of the second laser radiation with a detector,
wherein
the frequency of the laser radiation emitted by the laser changes at least during a second time interval, and
wherein the intensity of the first laser radiation is changed in a pulse-like manner during the first time interval.

12. The method of measuring distance according to claim 11, wherein at one or more points in time outside the first time interval at least 40% of the first laser radiation is absorbed by an electro-optical modulator and during the first time interval at most 10% of the first laser radiation is absorbed by the electro-optical modulator.

13. The method of measuring distance according to claim 11, wherein the intensity of the first laser radiation during the first time interval is increased by an amplifier compared to the intensity of the first laser radiation at at least some points in time outside the first time interval.

14. The method of measuring distance according to claims 11, wherein the distance of the object from the detector is determined from the transit time of the first laser radiation with the changed intensity across the object to the detector.

15. The method of measuring distance according to claim 14, wherein a speed of the object relative to the detector is determined from the determined distance and from the difference between the frequency of the second laser radiation and the frequency of the first laser radiation reflected at the object for first laser radiation and second laser radiation which impinge simultaneously on the detector at a point of time outside the first time interval.

16. The method of measuring distance according to claim 11, wherein the distance of the object from the detector is determined from the difference between the frequency of the second laser radiation and the frequency of the first laser radiation reflected at the object for first laser radiation and second laser radiation, which are simultaneously impinging on the detector at a point of time outside the first time interval.

17. The method of measuring distance according to claims 11, wherein the frequency of the laser radiation emitted by the laser increases linearly with time during the second time interval and the frequency of the laser radiation emitted by the laser decreases linearly with time during a third time interval.

18. The method of measuring distance according to claim 11, wherein the first time interval and the second time interval start simultaneously or the first time interval starts at most 200 ns after the second time interval.

19. The method of measuring distance according to claim 11 wherein the method is used to scan a plurality of points.
